(19) United States
(12) Patent Application Publication
(10) Pub. No.: US 2025/0086659 A1
(43) Pub. Date: Mar. 13, 2025

(54) APPARATUS AND METHOD FOR PRODUCING AND BROKERING TRANSACTIONS OF WATCHFACES BASED ON BLOCKCHAIN NETWORK

(71) Applicant: Apposter, Inc., Seoul (KR)

(72) Inventor: Sung Hyun Kyung, Gimpo-si (KR)

(73) Assignee: Apposter. Inc., Seoul (KR)

(21) Appl. No.: 18/495,238

(22) Filed: Oct. 26, 2023

(30) Foreign Application Priority Data
Sep. 13, 2023 (KR) 10-2023-0121479

(51) Int. Cl. G06Q 30/018; G06Q 20/12; G06Q 30/0601

(52) U.S. Cl. CPC G06Q 30/0185; G06Q 20/1235; G06Q 30/0633

(57) ABSTRACT

Disclosed is a watchface non-fungible token (NFT) creation and transaction system for creating a watchface and brokering transaction thereof based on a blockchain network. The watchface NFT creation and transaction system includes a creator terminal configured to create a watchface using a watchface creation application; a watchface NFT market server configured to: create a watchface NFT from the watchface; upload a resource of the watchface NFT to a distributed file system; and broker transaction of the watchface NFT via a watchface transaction web page; and a buyer terminal configured to purchase the watchface NFT via a watchface transaction web page.

### CROSS-REFERENCE TO RELATED APPLICATION

This application claims priority to and the benefit of Korean Patent Application No. 2023-0121479, filed on Sep. 13, 2023, the disclosure of which is incorporated herein by reference in its entirety.

### BACKGROUND OF THE INVENTION

### 1. Field of the Disclosure

The present disclosure (disclosure) generally relates to a blockchain network-based watchface NFT (non-fungible token) creation and transaction system. More specifically, the present disclosure relates to a device and method for creating a watchface NFT and promoting transaction of the watchface NFT using an NFT certification mark thereof.

### 2. Description of the Related Art

The blockchain network refers to a technology in which a ledger recording therein transaction information is distributed to a P2P network rather than a central server of a specific organization, and participants in the network jointly record and manage the ledger. In other words, blockchain technology operates in a way that multiple participants jointly manage data, thus making the traditional role of a central manager unnecessary. Further, an infrastructure cost for system construction is low. Integrity of data increases as the number of participants increases. This blockchain network is being utilized in various fields where contracts are carried out between multiple participants.

With continued development of intelligent wearable devices, smart watches are becoming popular, and the number of consumers wearing smart watches in their daily lives is gradually increasing. Consumers are wearing smart watches for various purposes such as fashion, business, health, and sports. In response thereto, smart watches of various styles are being released one after another.

A watchface of the smart watch refers to a screen displayed on a display of the smart watch. Because the watchface is displayed electronically, a screen design of the watchface may be freely changed, unlike a conventional analog watch. In other words, the smart watch allows the user to manually change a display form of the watchface, and the user may freely change display contents of the watchface corresponding to a display portion of the smartwatch so as to suit the user's mood, status, and style. Accordingly, watchfaces with various styles and functions are being designed, and specialized companies that support watchface design editing services are emerging.

Conventionally, when a creator creates a watchface and shares the created watchface online, a consumer downloads the watchface online and applies the same to his or her wearable device to set up the watchface thereon. In this regard, since the watchface is implemented using a software program, it was relatively easy to copy the watchface, and one watchface design was often used by multiple users. Accordingly, a conventional watchface NFT creation and transaction system had a problem of not meeting a need of a buyer who values a style of the watchface to have a unique watchface.

Unless otherwise indicated herein, materials as described in this Background section are not prior art to the claims of the present application. Despite the fact that the materials are included in this Background section, the materials are not admitted to be prior art.

A prior art literature to the present disclosure includes Koran Patent Application Publication No. 10-2020-0101209 2020.08.07)

### SUMMARY OF THE INVENTION

Based on the discussion described above, the present disclosure provides a device and method for creating a watchface NFT and storing the same in a blockchain network in a blockchain network-based watchface NFT (non-fungible token) transaction system.

Furthermore, the present disclosure provides a device and method for preventing forgery and falsification of the watchface NFT and improving the buyer's transaction reliability, by adding, to the watchface, an NFT certification mark indicating that the watchface has been implemented based on the NFT, and then creating the watchface NFT, in the watchface NFT creation and transaction system.

Furthermore, the present disclosure provides a device and method to improve security of the watchface NFT by adding a security mark related to the creator to the watchface in the watchface NFT creation and transaction system.

Furthermore, the present disclosure provides a device and method for preventing forgery and alteration of the watchface by creating a watchface from an NFT image and checking whether to add an NFT certification mark to the watchface in the watchface NFT creation and transaction system.

Furthermore, the present disclosure provides a device and method for promoting transaction of a watchface and a watchface NFT in the watchface NFT creation and transaction system.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means illustrated in the claims and combinations thereof.

According to a first aspect of the present disclosure, a watchface non-fungible token (NFT) creation and transaction system for brokering watchface transaction based on a blockchain network is provided. The watchface NFT creation and transaction system may include a creator terminal configured to create a watchface using a watchface creation application; a watchface NFT market server configured to: create a watchface NFT from the watchface; upload a resource of the watchface NFT to a distributed file system; and broker transaction of the watchface NFT via a watchface transaction web page; and a buyer terminal configured to purchase the watchface NFT via a watchface transaction web page.

In one implementation of the watchface NFT creation and transaction system, the watchface NFT market server may be configured to: transmit a decision request to decide whether to add an NFT certification mark to the watchface to the creator terminal; receive, from the creator terminal, a response indicating deciding to adding the NFT certification mark to the watchface; add the NFT certification mark to the watchface based on the reception of the response; and mint the watchface having the NFT certification mark added thereto to create the watchface NFT.

In one implementation of the watchface NFT creation and transaction system, the watchface NFT market server may be configured to: receive a purchase request of the watchface NFT from the buyer terminal; and provide the resource of the watchface NFT to the buyer terminal via the distributed file system.

In one implementation of the watchface NFT creation and transaction system, the watchface NFT market server may be configured to: extract a plurality of mark units from an identifier of the creator who has created the watchface; generate adding-related information about positions in the watchface at which the plurality of mark units are respectively added to the watchface; create a security mark based on the adding-related information; add the created security mark to the watchface to create a modified watchface; and mint the modified watchface to create the watchface NFT.

According to a second aspect of the present disclosure, a watchface non-fungible token (NFT) creation and transaction system for brokering watchface transaction based on a blockchain network is provided, wherein the watchface NFT creation and transaction system may include a creator terminal configured to obtain an NFT image from a digital wallet of a creator and to create a basic watchface displaying the NFT image using a watchface creation application; a watchface NFT market server configured to add an NFT certification mark to the basic watchface to create a combination watchface, and to broker transaction of the combination watchface via a watchface transaction web page; and a buyer terminal configured to purchase the combination watchface via the watchface transaction web page.

Various respective aspects and features of the present disclosure are defined in the appended claims. Combinations of the features of the dependent claims not only may be explicitly set forth in the claims but also may be combined with the features of the independent claims as appropriate.

Furthermore, one or more features selected from any one embodiment as described in the present disclosure may be combined with one or more features selected from any other embodiments as described in the present disclosure. Alternative combinations of these features may be possible as long as the alternative combinations of these features at least partially alleviate one or more of the technical problems as discussed in the present disclosure or at least partially alleviates technical problems that may be discernible by a person of ordinary skill in the art from the present disclosure. Further, specific combinations or permutations of the embodiment features as thus formed are possible as long as the skilled person to the art understands that the specific combinations or permutations of the embodiment features are not incompatible with each other.

In any example implementations as described in the present disclosure, two or more physically distinct components may alternatively be integrated into a single component, if such integration is feasible. As long as the integrated single component performs the same function, the integration is possible. Conversely, a single component of any embodiment as described in the present disclosure may alternatively, where appropriate, be implemented as two or more separate components that achieve the same functionality.

The purpose of certain embodiments of the present disclosure is to solve, alleviate or eliminate, at least in part, at least one of the problems and/or shortcomings related with the prior art. Certain embodiments aim to provide at least one of the advantages as described below.

The device and method according to various embodiments of the present disclosure may create the watchface NFT and store the same in a blockchain network and may broker the same in the blockchain network-based watchface NFT creation and transaction system.

Furthermore, the device and method according to various embodiments of the present disclosure may prevent forgery and falsification of the watchface NFT and improve the buyer's transaction reliability, by adding, to the watchface, the NFT certification mark indicating that the watchface has been implemented based on the NFT, and then creating the watchface NFT, in the watchface NFT creation and transaction system.

Furthermore, the device and method according to various embodiments of the present disclosure may improve security of the watchface NFT by adding the security mark related to the creator to the watchface in the watchface NFT creation and transaction system.

Furthermore, the device and method according to various embodiments of the present disclosure may prevent forgery and alteration of the watchface by creating the watchface from the NFT image and checking whether to add an NFT certification mark to the watchface in the watchface NFT creation and transaction system.

Furthermore, the device and method according to various embodiments of the present disclosure may promote the transaction of the watchface and the watchface NFT in the watchface NFT creation and transaction system.

Effects of the present disclosure are not limited to the effects mentioned above, and other effects not mentioned will be clearly understood by those skilled in the art from the descriptions below.

### BRIEF DESCRIPTION OF THE DRAWINGS

The accompanying drawings included as a portion of the detailed description to aid understanding of the embodiments provide various embodiments, and describe technical features of the various embodiments along with the detailed descriptions. The accompanying drawings are as follows:

FIG. 1 shows a watchface NFT creation and transaction system according to various embodiments of the present disclosure;

FIG. 2 shows a schematic diagram of components of the watchface NFT creation and transaction system according to various embodiments of the present disclosure;

FIG. 3 shows a configuration of a watchface NFT market server in the watchface NFT creation and transaction system according to various embodiments of the present disclosure;

FIG. 4 shows a schematic diagram of a transaction process of a watchface NFT in the watchface NFT creation and transaction system according to various embodiments of the present disclosure;

FIG. 5 shows an example of a watchface creation application and a NFT certification mark in the watchface NFT creation and transaction system according to various embodiments of the present disclosure;

FIG. 6 shows a flowchart for brokering transaction of a watchface NFT in the watchface NFT creation and transaction system according to various embodiments of the present disclosure;

FIG. 7 shows a flowchart for brokering transaction of a watchface created from an NFT image in the watchface NFT creation and transaction system according to various embodiments of the present disclosure; and

FIG. 8 shows a flowchart for operating a watchface NFT market server in the watchface NFT creation and transaction system according to various embodiments of the present disclosure.

### DETAILED DESCRIPTION OF THE INVENTION

The terminology used herein is for the purpose of describing particular embodiments only and is not intended to limit the present disclosure. As used herein, the singular forms “a” and “an” are intended to include the plural forms as well, unless the context clearly refers to otherwise. Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Various embodiments of the present disclosure as described below are based on a hardware scheme by way of example. However, the present disclosure is not limited thereto. Because the various embodiments of the present disclosure include using both hardware and software, the various embodiments of the present disclosure do not exclude a software-based scheme.

The present disclosure as described below provides a blockchain network-based watchface NFT (non-fungible token) creation and transaction system. Specifically, the present disclosure describes a scheme for creating the watchface NFT and activating the watchface NFT transaction by adding an NFT certification mark thereto.

Hereinafter, with reference to the attached drawings, the various embodiments are described in detail so that those skilled in the art may easily perform the various embodiments. However, the technical idea of the present disclosure may be modified and implemented in various forms. Thus, the present disclosure is not limited to the embodiments as described herein. In describing the embodiments as disclosed herein, when it is determined that a detailed description of a related known component or step may obscure the gist of the technical idea of the present disclosure, the detailed description thereof will be omitted. Identical or similar components will be assigned the same reference numerals and duplicate descriptions thereof will be omitted.

It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof.

Some embodiments may be described in terms of functional block components and various processing steps. Some or all of these functional blocks may be implemented as various numbers of hardware and/or software components that perform specific functions. For example, the functional blocks of the present disclosure may be implemented by one or more microprocessors, or may be implemented by circuit components for a given function. The functional blocks of the present disclosure may be implemented in a variety of programming or scripting languages. The functional blocks of the present disclosure may be implemented as algorithms executed on one or more processors. A function performed by a function block of the present disclosure may be performed by a plurality of function blocks, or functions performed by a plurality of function blocks of the present disclosure may be performed by a single function block. Furthermore, the present disclosure may employ prior art techniques for electronic configuration setting, signal processing, and/or data processing.

Furthermore, as used herein, the expression “greater than” or “smaller than” may be used to determine whether a certain condition is satisfied or fulfilled. However, the expression is only a description to express an example, and the expression “greater than or equal to” or “smaller than or equal to” may not be excluded. A condition including the expression “greater than” may be replaced with a condition including the expression “greater than or equal to”, or vice versa. Further, a condition including the expression “smaller than” may be replaced with a condition including the expression “smaller than or equal to”, or vice versa.

Furthermore, as used herein, an image refers to an image shaped so as to visually capture information by light rays or media arranged on a plane or in space, and may include still images and moving images, and may refer to an NFT image created based on NFT.

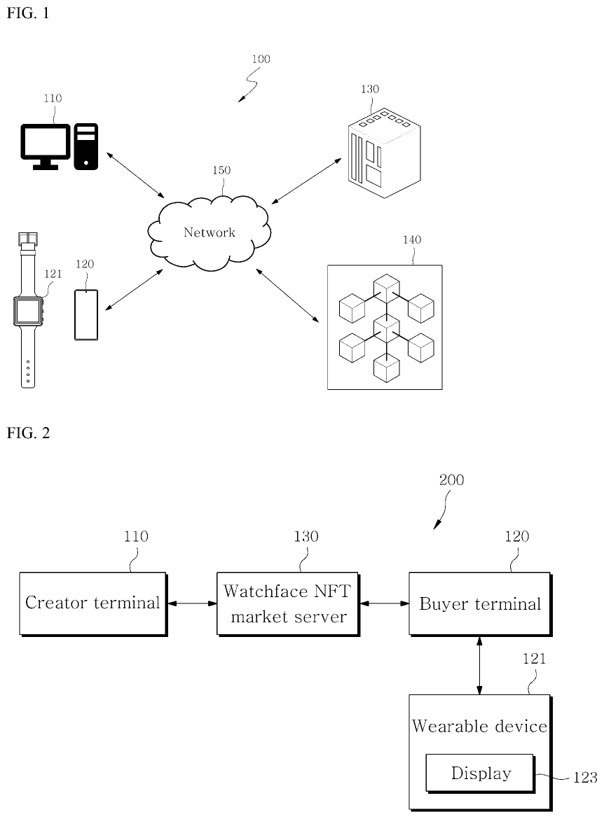

FIG. 1 shows a watchface NFT creation and transaction system 100 according to various embodiments of the present disclosure. The watchface NFT creation and transaction system 100 refers to a system that brokers transaction of the watchface NFT online. Specifically, the watchface NFT creation and transaction system 100 refers to a system in which transactions of the watchface or the watchface NFT between users are made through a watchface transaction web page. According to the watchface NFT creation and transaction system 100, a creator may create a watchface according to his or her taste or intention using a watchface creation application, and a buyer may purchase the watchface created by the creator. In this regard, a brokerage service provider may connect the creator and the buyer to each other so that the transaction may occur between the creator and the buyer. Specifically, the brokerage service provider may create the watchface NFT using the watchface created by the creator and store the watchface NFT in the blockchain network. Afterwards, the brokerage service provider may broker the transaction of the watchface NFT by selling the watchface NFT in response to the buyer's request. According to one embodiment of the present disclosure, the watchface NFT creation and transaction system 100 may include a creator terminal 110, a buyer terminal 120, a wearable device 121, a watchface NFT market server 130, and a blockchain network 140, and a network 150.

The creator terminal 110 refers to an electronic device operated by the creator who creates and sells a watchface. The creator may create the watchface using the creator terminal 110, and may request watchface transaction brokerage to the brokerage service provider that brokers the watchface transactions. In other words, the creator terminal 110 may be equipped with the watchface creation application to create the watchface, and the creator may create the watchface by designing the watchface using the watchface creation application. According to one embodiment of the present disclosure, the creator terminal 110 may include a fixed terminal or a mobile terminal implemented as a computer device. Specifically, the creator terminal 110 may refer to a smart phone, a mobile phone, a navigation device, a computer, a laptop, a digital broadcasting terminal, a personal digital assistant (PDA), a portable multimedia player (PMP), or a tablet PC.

The buyer terminal 120 refers to an electronic device operated by the buyer purchasing the watchface or the watchface NFT. The buyer may access the watchface transaction web page using the buyer terminal 120 and purchase the watchface or the watchface NFT, and then may apply the purchased watchface to the wearable device 121. According to one embodiment of the present disclosure, the buyer terminal 120 may include a fixed terminal or a mobile terminal implemented as a computer device.

The wearable device 121 refers to a wearable computing device that the buyer may wear. The wearable device 121 may refer to a computer in a wearable form, such as a watch or glasses. Hereinafter, the wearable device 121 refers to the smart watch. However, the present disclosure is not limited thereto.

The watchface NFT market server 130 refers to a device operated by the brokerage service provider that operates an online shopping mall for transactions of the watchface and the watchface NFT. The watchface NFT market server 130 may perform overall functions required in a process in which the creator and the buyer perform transaction of the watchface with each other. In this regard, the transaction may include a single price transaction and an auction-based transaction. The watchface NFT market server 130 may allow the watchface or the watchface NFT to be transacted between the creator and the buyer through the watchface transaction website. In this regard, the brokerage service provider may mint the watchface created by the seller to create the watchface NFT and store the watchface NFT in the blockchain network in a distributed manner. When there is a purchase request from the buyer, the brokerage service provider may perform the transaction through a virtual wallet of each of the seller and the buyer, thereby brokering the watchface transaction. According to one embodiment of the present disclosure, the watchface NFT market server 130 may be implemented as a computer device or a plurality of computer devices that provide instructions, codes, files, contents, services, etc., and may store, in database, various data such as information for operating the shopping mall, and watchface NFT sales information.

The blockchain network 140 refers to network nodes that use blockchain technology. Specifically, the blockchain network 140 may refer to a network based on the P2P scheme as implemented by technology in which the data to be managed is stored in a distributed data storage environment called a ‘block’ which is formed by connecting small data to each other in a chain manner, so that no one may arbitrarily modify the stored data, and anyone can see the result of the change of the data. All data that have been propagated to users before a specific block has been discovered are recorded in the specific block and may be equally transmitted to all users in a P2P manner. Therefore, users cannot arbitrarily modify or omit the data. The block has a discovery date and has a line to a previous block, and a collection of these blocks may be called a blockchain, and blockchain technology may be a technology that bundles numerous records. When the watchface NFT market server 130 receives information about an user address, a configuration, and a price about the watchface NFT, the watchface NFT market server 130 may store the received information in the blockchain network 140 via an interplanetary file system (IPFS).

As shown in FIG. 1, the components of the watchface NFT creation and transaction system 100 may be connected to each other through the network 150. According to one embodiment of the present disclosure, the network 150 refers to a connection structure that allows information exchange between nodes such as a plurality of terminals and servers. Examples of such a network may include RF, 3GPP 3rd generation partnership project) network, LTE (long term evolution) network, 5GPP 5rd generation partnership project) network, WIMAX (world interoperability for microwave access) network, Internet, LAN (local area network), Wireless LAN (wireless local area network), a wide area network (WAN), a personal area network (PAN), a Bluetooth network, an NFC network, a satellite broadcasting network, an analog broadcasting network, and a digital multimedia broadcasting (DMB) network. However, the present disclosure is not limited thereto.

According to the watchface NFT creation and transaction system 100, the creator may deliver the watchface that the creator has created to the brokerage service provider. The brokerage service provider may mint the received watchface to create a watchface NFT, and may upload the created watchface NFT to a decentralized or distributed file system, and thus may store the watchface NFT in the blockchain network. In this regard, the distributed file system may be a P2P (peer to peer) distributed network that may host and back up data into multiple nodes, and may refer to IPFS. Furthermore, the brokerage service provider may upload sales information of the watchface NFT to the watchface transaction web page, and the buyer may identify the sales information of the watchface NFT and purchase the same. In this way, the watchface transaction may be made.

In this regard, in a process of creating the watchface NFT, the brokerage service provider may add an NFT certification mark to the watchface and then mint the watchface having the NFT certification mark added thereto to create the watchface NFT. The NFT certification mark may prove that the watchface has been implemented based on the NFT. Hereinafter, a specific configuration and an operation of the watchface NFT creation and transaction system 100 are described in detail.

FIG. 2 shows a schematic diagram 200 of the components of the watchface NFT creation and transaction system 100 according to various embodiments of the present disclosure.

The creator terminal 110 performs the function of creating=watchface using the watchface creation application and delivering the same to the brokerage service provider. The creator terminal 110 may create the watchface by combining and editing watchface assets with each other. Specifically, the creator may create the watchface via the watchface creation application displayed on the display of the creator terminal 110. The creator terminal 110 may transmit the created watchface to the watchface NFT market server 130 along with a sales condition desired by the creator. In this regard, the sales condition may include the transaction condition of the watchface desired by the creator. According to one embodiment of the present disclosure, the sales condition may include a desired sales price, a desired minimum bid price, a transaction availability period, and a transaction availability limit.

The buyer terminal 120 performs the function of purchasing and downloading the watchface NFT through an online shopping mall. The buyer terminal 120 may check the watchface transaction web page to identify the watchface NFT it wishes to purchase and request a purchase of the identified watchface NFT. Afterwards, the buyer terminal 120 may transmit the purchased watchface NFT to the wearable device 121. Accordingly, the wearable device 121 may display the watchface NFT purchased by the buyer on the display 123 thereof.

The watchface NFT market server 130 may broker the watchface NFT transaction between the creator and the buyer using the watchface received from the creator terminal 110. The watchface NFT market server 130 may create the watchface NFT from the received watchface, and may upload the watchface NFT to the decentralized file system. Furthermore, the watchface NFT market server 130 may upload the sales information of the watchface NFT to the watchface transaction website, and may support provision of and payment service for the watchface NFT in response to a buyer requesting purchase thereof.

Additionally, the watchface NFT market server 130 may upload the watchface created from an NFT image to the watchface transaction website broker and thus may broker the transaction of the NFT image-based watchface. That is, the watchface NFT market server 130 may control the watchface transaction web page in which the transaction of the watchface including the NFT image and the watchface NFT.

The watchface NFT market server 130 may add the NFT certification mark to the watchface so that the buyer who purchased the watchface may identify that the watchface he/she has purchased has been implemented based on the NFT. In other words, the watchface NFT market server 130 may add the NFT certification mark to indicate that the watchface has been implemented based on the NFT, unlike a traditional watchface, and the wearable device 121 may display the watchface having the NFT certification mark applied thereto on the display. Hereinafter, a specific scheme in which the watchface NFT market server 130 brokers the transactions of the NFT image-based watchface and the watchface NFT, and adds the NFT certification mark to the watchface is described in detail.

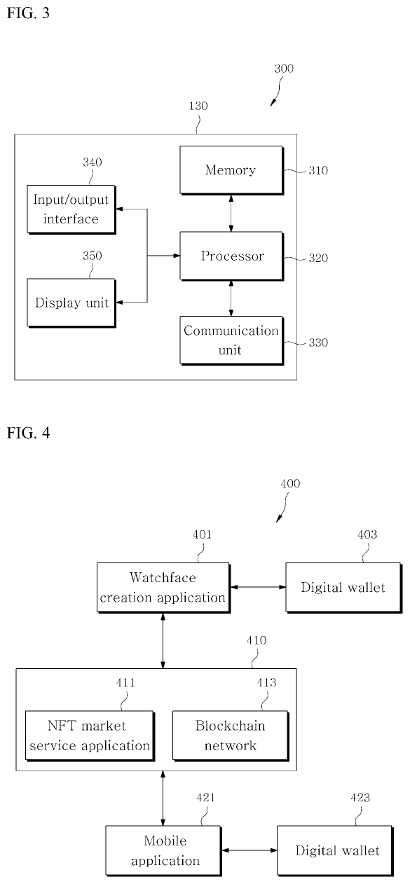

FIG. 3 shows a configuration 300 of the watchface NFT market server 130 in the watchface NFT creation and transaction system 100 according to various embodiments of the present disclosure.

Terms such as ‘ . . . unit’ as used hereinafter mean a unit that processes at least one function or operation, and which may be implemented in hardware or software, or a combination of hardware and software. The watchface NFT market server 130 may include a memory 310, a processor 320, a communication unit 330, an input/output interface 340, and a display unit 350.

The memory 310 temporarily or permanently stores therein data such as basic programs, applications, and setting information for the operation of the watchface NFT market server 130. The memory 310 may include a permanent mass storage device such as random access memory (RAM), read only memory (ROM), and disk drive. However, the present disclosure is not limited thereto. These software components may be loaded from a computer-readable recording medium separate from the memory 310 using a drive mechanism. The separate computer-readable recording media may include computer-readable recording media such as floppy drives, disks, tapes, DVD/CD-ROM drives, and memory cards. According to an embodiment, the software components may be loaded into the memory 310 through the communication unit 330 rather than the computer-readable recording medium. Furthermore, the memory 310 may provide the stored data upon request from the processor 320. According to one embodiment of the present disclosure, the memory 310 may store therein watchface information about a configuration and a sales condition of the created watchface.

The processor 320 controls overall operations of the watchface NFT market server 130. For example, the processor 320 may control the communication unit 330 to transmit or receive a signal. Furthermore, the processor 320 may be configured to process instructions of a computer program by performing basic arithmetic, logic, and input/output operations. The instructions may be provided to the processor 320 via the memory 310 or the communication unit 330. For example, the processor 320 may be configured to execute the received instructions according to program codes stored in a recording device such as the memory 310. For example, the processor 320 may control the watchface NFT market server 130 to perform operations according to various embodiments as described later.

According to one embodiment of the present disclosure, the processor 320 may generate the watchface NFT from the watchface, and may upload a resource of the watchface NFT to the decentralized file system, and may broker the transaction of watchface NFT through the watchface transaction web page. According to one embodiment of the present disclosure, the processor 320 may add the NFT certification mark to a basic watchface to create a combination watchface and may broker the transaction of the combination watchface through the watchface transaction web page.

The communication unit 330 performs functions for transmitting and receiving signals through a wireless channel. An entirety or a portion of the communication unit 330 may be referred to as a transmitting unit, a receiving unit, or a transmitting/receiving unit. The communication unit 330 may allow the watchface NFT market server 130 and at least one further node to communicate with each other through a communication network. According to one embodiment of the present disclosure, when the processor 320 of the watchface NFT market server 130 generates a request signal according to a program code stored in a recording device such as the memory 310, the request signal may be transmitted to at least one further node through the communication network under control of the communication unit 330. Conversely, a control signal, instructions, content, files, etc. provided according to control of a processor of the at least one further node may be received by the watchface NFT market server 130 through the communication unit 330. According to one embodiment of the present disclosure, the communication unit 330 may receive the watchface from the creator terminal 110. Furthermore, the communication unit 330 may receive a purchase request for the watchface from the buyer terminal 120.

The input/output interface 340 may be means for interfacing with an input/output device (not shown). In this regard, the input device may be, for example, a device such as a keyboard or mouse, and the output device may be provided in a form of a device such as a display unit for displaying images. In another example, the input/output interface 340 may be means for interfacing with a device in which input and output functions are integrated with each other, such as a touch screen. Specifically, when the processor 320 of the watchface NFT market server 130 processes the instructions of the computer program loaded in the memory 310, the service screen or contents constructed using data provided from the server may be displayed on the display via the input/output interface 340. According to one embodiment of the present disclosure, the input/output interface 340 may include means for interfacing with the display unit 350. The input/output interface 340 may receive a user input to a web browsing window displayed on the display unit 350, and may receive, from the processor 320, output data to be output through the display unit 350 from the processor 320 in response to the above-described user input. According to one embodiment of the present disclosure, the input/output interface 340 may receive a control signal for the watchface NFT transaction.

The display unit 350 refers to a display module including one or more displays. Each of the one or more displays included in the display unit 350 may individually display independent content, and the one or more displays as described above may be combined with each other to display single content. According to an embodiment of the present disclosure, the one or more displays included in the display unit 350 may include multiple physically separated displays, may be multiple physically combined displays, or may be a display in which one screen is divided into multiple sub-screens. According to one embodiment of the present disclosure, the display unit 350 may display the transaction status of the watchface NFT on the display.

The watchface NFT market server 130 may receive the design of the watchface, a composition of assets thereof, and sales conditions thereof from the creator terminal 110. Afterwards, the watchface NFT market server 130 may create the watchface NFT using watchface, may store the watchface NFT in the blockchain network by storing the resources of the watchface NFT in the distributed file system. Afterwards, the watchface NFT market server 130 may upload watchface sales information through the watchface transaction web page, and the buyer terminal 120 may purchase the watchface NFT through the watchface transaction web page and may apply the watchface of the watchface NFT to the wearable device 121 and may use the watchface on the wearable device.

The watchface NFT market server 130 may add the NFT certification mark to the watchface so that the buyer may intuitively identify that the watchface has been implemented based on the NFT. In other words, the watchface NFT market server 130 may generate mark information about the NFT certification mark to be added to the watchface, and may add the NFT certification mark to the watchface based on the mark information and may mint the watchface having the NFT certification mark added thereto to create the watchface NFT. The watchface NFT market server 130 may encourage the buyer's desire to purchase the watchface NFT by delivering the watchface NFT having the NFT certification mark added thereto in response to the buyer's purchase request.

FIG. 4 shows a schematic diagram 400 of a transaction process of the watchface NFT in the watchface NFT creation and transaction system 100 according to various embodiments of the present disclosure.

Referring to FIG. 4, the creator may create the watchface using the watchface creation application 401. The creator may design the watchface by combining and arranging the watchface assets with each other using the watchface creation application 401 installed on the creator terminal 110. According to one embodiment of the present disclosure, the watchface asset may be classified as one of a background image asset, a watch asset, a notification information asset, and a text asset. Thus, the creator may combine the watchface assets with each other using the watchface creation application 401 to create the watchface. Afterwards, the creator may deliver the watchface to a watchface NFT marketplace 410. To this end, a digital wallet 403 may be linked to the watchface NFT marketplace 410.

The watchface NFT marketplace 410 refers to a functional unit that is performed on the watchface NFT market server 130 and performs a function of minting the watchface to create the watchface NFT and of storing the same in the blockchain network, and of selling the watchface NFT. In other words, digital wallet connection, NFT minting, API call for watchface transaction, uploading of the watchface NFT to IPFS, etc. may be performed via the watchface NFT marketplace 410. Accordingly, the NFT certification mark may be added to the watchface created in the watchface creation application 401, and then the watchface having the NFT certification mark added thereto may be minted via the watchface NFT marketplace 410 to create the watchface NFT which in turn may be stored in the blockchain network 413. According to one embodiment of the present disclosure, the resources of the created watchface NFT may be stored in the distributed file system through the watchface NFT marketplace 410. Furthermore, a NFT market service application 411 for watchface NFT transaction may be called from the watchface NFT marketplace 410. Sales information of the watchface NFT may be uploaded to the watchface transaction web page through the NFT market service application, and a transaction brokerage service subscriber may identify the watchface NFT being sold through the web page.

The buyer may access the watchface transaction web page through a mobile application 421, and may select the watchface NFT that the buyer wishes to purchase and request a purchase thereof. When the buyer requests a purchase of the selected watchface NFT, the watchface NFT market server 130 may transfer the resources of the watchface NFT from the distributed file system to the buyer terminal 120 To this end, a digital wallet 423 may be linked to the watchface NFT marketplace 410. The buyer may purchase the selected watchface NFT and then transfer the same to the wearable device 121 and may use the purchased watchface on the wearable device 121.

In a process in which the watchface NFT market server 130 mints the watchface into the watchface NFT, the watchface NFT market server 130 may add the NFT certification mark to the watchface. Thus, when the buyer purchases the watchface NFT in the watchface NFT marketplace 410 and applies the same to the wearable device, the buyer may identify, based on the NFT certification mark, that the watchface has been implemented based on the NFT. As the watchface NFT is stored into the blockchain network, it is difficult to replicate the watchface NFT, and the watchface NFF has unique characteristics. In this regard, the watchface NFT market server 130 may add the NFT certification mark to the watchface to encourage the buyer to purchase the watchface NFT.

The NFT certification mark may refer to any mark that performs a function to indicate that the watchface has been implemented based on the NFT. According to one embodiment of the present disclosure, the NFT certification mark may refer to a circular image of a preset color and shape, a geometric image such as a hexagon, and an image of any form to indicate that the watchface has been implemented based on the NFT. The NFT certification mark may be added to a background of a watchface screen and may be displayed.

Specifically, the watchface NFT market server 130 may generate watchface NFT mark information about the NFT certification mark to be added to the watchface in the process of creating the watchface NFT. The watchface NFT market server 130 may select an NFT certification mark corresponding to a color of a background image asset of the watchface, and the mark information may indicate selection information related to the NFT certification mark. For example, the watchface NFT market server 130 may extract a main color from the background image asset of the watchface, and may select a hexagon-shaped image in a complementary color to the main color as the NFT certification mark. The watchface NFT market server 130 may add the NFT certification mark to the watchface using the mark information, and may mint the watchface having the NFT certification mark attached thereto to create the watchface NFT. In this way, the watchface NFT having the NFT certification mark added thereto to indicate that the watchface has been implemented based on the NFT may be created.

The watchface NFT market server 130 may upload the sales information such as sales conditions and price of the watchface received from the creator terminal 110 to the watchface transaction web page. After the buyer checks the sales information of the watchface NFT on the watchface transaction web page, the buyer may send a purchase request of the watchface NFT he/she wants to purchase. When the watchface NFT market server 130 has received the purchase request of the watchface NFT from the buyer terminal, the watchface NFT market server 130 may deliver the resources of the watchface NFT to the buyer terminal 120 through the distributed file system. The buyer terminal 120 may deliver the watchface NFT provided from the distributed file system to the wearable device 121 on which the watchface of the watchface NFT may be used.

When the creator creates the watchface from an NFT image stored in the digital wallet 403 using the watchface creation application 401, the watchface NFT market server 130 may provide the creator or the buyer with an option of deciding whether to add the NFT certification mark to the watchface. When creating the watchface using the NFT image, the created watchface may have unique characteristics even though the created watchface is not converted into the watachface NFT. Optionally, the watchface NFT market server 130 may add the NFT certification mark to the watchface created using the NFT image. In this regard, the watchface NFT market server 130 may provide the creator or the buyer with an option of deciding whether to add the NFT certification mark to the watchface.

Specifically, the watchface NFT market server 130 identifies whether the received watchface is a watchface created using an NFT image. According to one embodiment of the present disclosure, the watchface NFT market server 130 may identify whether the watchface has been created from the NFT image based on a determination result of whether the NFT image has been used in the watchface creation application 401. When the watchface has been created from the NFT image, the watchface NFT market server 130 may generate the watchface NFT mark information about the NFT certification mark to be added to the watchface. According to one embodiment of the present disclosure, the watchface NFT market server 130 may extract the main color from the background image asset of the watchface, and may select a circular shape in a complementary color to the main color as the NFT certification mark. Afterwards, the watchface NFT market server 130 may transmit a decision request to the creator terminal 110 to decide whether to apply the selected NFT certification mark. Then, the watchface NFT market server 130 may receive a response indicating the adding of the NFT certification mark from the creator terminal 110. Then, the watchface NFT market server 130 may add the NFT certification mark to the watchface in response to the reception of the response.

Afterwards, the watchface NFT market server 130 may sell the watchface created from the NFT image using the same procedure as the sales procedure applied to the watchface NFT. The watchface NFT market server 130 may upload sales information about the watchface created from the NFT image or the watchface NFT obtained by minting the watchface created from the NFT image to the watchface transaction web page, and may receive the purchase request of the watchface created from the NFT image or the watchface NFT obtained by minting the watchface created from the NFT image from the buyer terminal 120. When the watchface NFT market server 130 has received the purchase request of the watchface created from the NFT image or the watchface NFT obtained by minting the watchface created from the NFT image, the watchface NFT market server 130 may transmit the resources of the watchface created from the NFT image or the watchface NFT obtained by minting the watchface created from the NFT image through the distributed file system to the buyer terminal 120. The buyer terminal 120 may transfer the resources of the watchface created from the NFT image or the watchface NFT obtained by minting the watchface created from the NFT image as provided from the distributed file system to the wearable device 121 on which the watchface created from the NFT image or the watchface NFT obtained by minting the watchface created from the NFT image may be used.

To further strengthen the security of the watchface NFT, the watchface NFT market server 130 may create a security mark from an identifier of the creator who has created the watchface. The watchface NFT market server 130 may extract a plurality of mark units from the creator identifier, and may generate adding-related information about an order in, locations to, and a scheme in which the plurality of mark units are added. Afterwards, the watchface NFT market server 130 may generate the security mark from the plurality of mark units using the adding-related information, and may add the created security mark to the watchface to create a modified watchface. The watchface NFT market server 130 may mint the modified watchface to create the watchface NFT.

Specifically, the watchface NFT market server 130 may extract the plurality of mark units from the creator identifier. The creator identifier may refer to a personal identification number (PIN) number of the creator composed of a plurality of letters or numbers. The watchface NFT market server 130 may decompose the creator identifier into characters to extract the plurality of mark units therefrom. According to one embodiment of the present disclosure, when the creator identifier is 132465, the watchface NFT market server may extract 1, 3, 2, 4, 6, and 5 as the plurality of mark units.

Afterwards, the watchface NFT market server 130 may generate the adding-related information about an order in, locations to, and a scheme in which the plurality of mark units are added. Within the screen of the watchface, a plurality of pixels may be arranged according to a shape pattern, and the adding-related information may indicate positions at which the mark units are arranged according to the shape pattern.

The watchface NFT market server 130 may determine the shape pattern according to the number of mark units, and may respectively position the plurality of mark units at vertex locations of the shape pattern. For example, when the plurality of mark units are 1, 3, 2, 4, 6, and 5, the watchface NFT market server 130 may determine a hexagonal shape pattern, and may position 1, 3, 2, 4, 6, and 5 to the 6 vertexes of the hexagon, respectively. Accordingly, the positions of the mark units 1, 3, 2, 4, 6, and 5 within the watchface screen may be determined.

The watchface NFT market server 130 creates the security mark using the adding-related information. After the mark units have been positioned, the watchface NFT market server 130 may change a RGB color value of the pixel at the position where each of the mark units is positioned. According to one embodiment of the present disclosure, the watchface NFT market server 130 may create the security mark by changing the RGB color value of the pixel at the position where each of the mark units is positioned into a value obtaining by subtracting a value corresponding to each mark unit from the RGB color value of the pixel where each mark unit is positioned. Since the buyer is likely to recognize the security mark when the color change is large, the watchface NFT market server 130 may determine the color of the unit mark to be similar to a surrounding color therearound so that the buyer cannot detect the mark with the naked eye. For example, after the mark units 1, 3, 2, 4, 6, and 5 have been positioned at the vertexes of the hexagonal shape pattern, respectively, the watchface NFT market server 130 may change a first RGB color value of the pixel at the position where the mark unit 1 is positioned into a value obtaining by subtracting 1 from the first RGB color value, may change a second RGB color value of the pixel at the position where the mark unit 3 is positioned into a value obtaining by subtracting 3 from the second RGB color value, may change a third RGB color value of the pixel at the position where the mark unit 2 is positioned into a value obtaining by subtracting 2 from the third RGB color value, may change a fourth RGB color value of the pixel at the position where the mark unit 4 is positioned into a value obtaining by subtracting 4 from the fourth RGB color value, may change a fifth RGB color value of the pixel at the position where the mark unit 6 is positioned into a value obtaining by subtracting 6 from the fifth RGB color value, and may change a sixth RGB color value of the pixel at the position where the mark unit 6 is positioned into a value obtaining by subtracting 6 from the sixth RGB color value. Thus the watchface NFT market server 130 may create the security mark.

The watchface NFT market server 130 may add the security mark to the watchface to create the modified watchface and may mint the modified watchface to create the watchface NFT. The watchface NFT created in this way has high security because the security mark corresponding to the creator identifier has been added thereto.

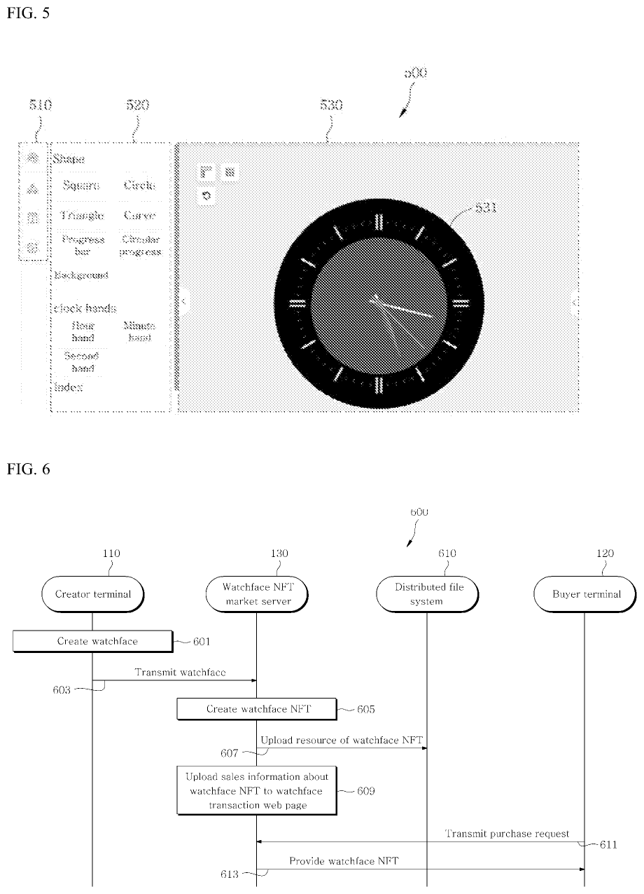

FIG. 5 shows an example 500 of the watchface creation application 401 and the NFT certification mark in the watchface NFT creation and transaction system 100 according to various embodiments of the present disclosure.

Referring to FIG. 5, the watchface creation application 401 refers to an application to create the watchface by editing the watchface assets. In this regard, the watchface asset may refer to images or text needed for creating the watchface. FIG. 5 is intended to illustrate an example of the watchface assets and illustrates a watchface creation screen through the watchface creation application 401.

According to the watchface creation screen, a first area 510 displays a screen for selecting watchface asset editing contents, a second area 520 displays a screen for setting a specific editing method of the selected watchface asset editing contents, and a third area 530 displays a preview screen of a watchface sample 531 currently being created. Although not shown in FIG. 5, the watchface asset may be classified as one of the background image asset, the watch asset, the notification information asset, and the text asset. The creator may create the watchface assets directly or may purchase the created watchface assets, and may create the watchface using the watchface assets.

FIG. 6 shows a flowchart 600 for illustrating a method for brokering transaction of the watchface NFT in the watchface NFT creation and transaction system 100 according to various embodiments of the present disclosure.

Referring to FIG. 6, in step 601, the creator terminal 110 creates the watchface. The creator may create the watchface by combining the watchface assets with each other using the watchface creation application 401. The creator terminal 110 may create the watchface based on the creator's input.

In step 603, the creator terminal 110 transmits the watchface to the watchface NFT market server 130. The creator terminal 110 may transmit the created watchface to the watchface NFT market server 130. At this time, the creator terminal 110 may transmit the sales information about the sales price and sales period of the watchface.

In step 605, the watchface NFT market server 130 creates the watchface NFT. The watchface NFT market server 130 may create the watchface NFT from the received watchface. The watchface NFT market server 130 may transmit the decision request to the creator terminal to decide whether to add the NFT certification mark to the watchface, and may receive the response to the request indicating that the creator decides to add the NFT certification mark to the watchface from the creator terminal. In response to the reception of the response, the watchface NFT market server 130 may select the NFT certification mark in consideration of the background image asset of the watchface and may generate the watchface NFT mark information indicating the selection result of the NFT certification mark. Afterwards, the watchface NFT market server 130 may add the selected NFT certification mark to the watchface according to the mark information, and then may mint the watchface having the NFT certification mark added thereto to create the watchface NFT.

In step 607, the watchface NFT market server 130 uploads the resources of the watchface NFT to the distributed file system 610. The watchface NFT market server 130 may store the watchface NFT in the blockchain network. According to one embodiment of the present disclosure, the watchface NFT market server 130 may store the resources of the watchface NFT in the blockchain network through IPFS. Accordingly, the watchface NFT may be stored in a distributed manner.

In step 609, the watchface NFT market server 130 uploads the sales information about the watchface NFT to the watchface transaction web page. The watchface NFT market server 130 may upload the sales conditions and sales price of the watchface NFT and a watchface sample image to the watchface transaction web page. The watchface NFT market server 130 may broker watchface transaction based on the sales conditions. For example, the watchface NFT market server 130 may upload the sales price, the sales period, and a sales quantity to the watchface transaction web page for single price sales. Furthermore, the watchface NFT market server 130 may upload a minimum bid price, a minimum bid unit, and an auction date to the watchface transaction web page in order to proceed with the transaction based on auction.

In step 611, the buyer terminal 120 transmits the purchase request of the watchface NFT to the watchface NFT market server 130. The buyer terminal 120 may search for the watchface the buyer wants to purchase through the watchface transaction web page, and may transmit the purchase request thereof to the watchface NFT market server 130.

In step 613, the watchface NFT market server 130 provides the watchface NFT to the buyer terminal 120. The watchface NFT market server 130 may allow the resource of the watchface NFT to be transferred to the buyer terminal through the distributed file system 610 in response to the receipt of the purchase request. The buyer may transmit the watchface NFT having the NFT certification mark added thereto to the wearable device 121 on which the watchface of the watchface NFT may be used.

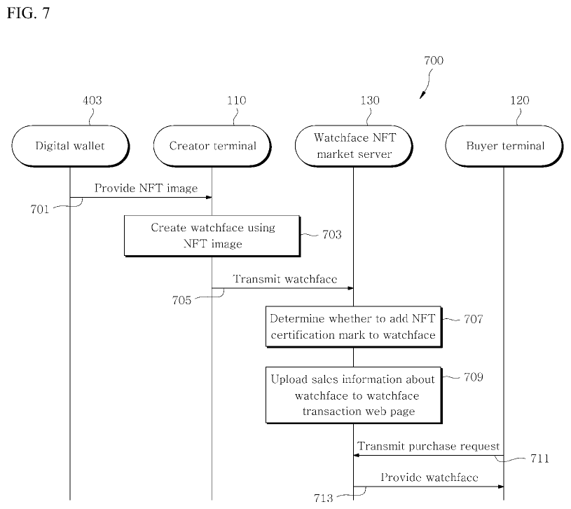

FIG. 7 shows a flowchart 700 for illustrating a method for brokering transaction of the watchface created from the NFT image in the watchface NFT creation and transaction system 100 according to various embodiments of the present disclosure. FIG. 7 illustrates a scheme in which the watchface NFT market server 130 brokers the watchface created from the NFT image without creating the watchface NFT.

Referring to FIG. 7, in step 701, the creator terminal 110 receives the NFT image from the digital wallet 403. The creator terminal 110 may acquire the NFT image stored in the digital wallet 403 therefrom.

In step 703, the creator terminal 110 creates the watchface using the NFT image. The creator may create the watchface from the NFT image by using the NFT image as a watchface background image asset. According to one embodiment of the present disclosure, the creator terminal 110 may create the basic watchface displaying the NFT image using the watchface creation application.

In step 705, the creator terminal 110 transmits the basic watchface to the watchface NFT market server 130. The creator terminal 110 may transmit the basic watchface displaying the NFT image to the watchface NFT market server.

In step 707, the watchface NFT market server 130 determines whether to add the NFT certification mark to the basic watchface. To this end, the watchface NFT market server 130 may query at least one of the creator or the buyer whether the at least one of the creator or the buyer wants to add the NFT certification mark to the basic watchface. The watchface NFT market server 130 may determine whether the NFT certification mark is to be added thereto, based on the response to the query. According to one embodiment of the present disclosure, when the watchface NFT market server 130 determines that the NFT certification mark is not to be added thereto, based on the response to the query, the watchface NFT market server 130 may use the basic watchface itself received from the creator terminal 110 as the watchface to be sold. According to another embodiment of the present disclosure, when the watchface NFT market server 130 determines that the NFT certification mark is to be added thereto, based on the response to the query, the watchface NFT market server 130 may select the NFT certification mark in consideration of the color of the background image of the watchface. In this case, the watchface NFT market server 130 may add the NFT certification mark to the basic watchface to create the combination watchface.

In step 709, the watchface NFT market server 130 uploads the sales information of the combination watchface to the watchface transaction web page. The watchface NFT market server 130 may upload the sales conditions and the sales price of the combination watchface, and the watchface sample image to the watchface transaction web page.

In step 711, the buyer terminal 120 transmits the purchase request of the combination watchface to the watchface NFT market server 130. The buyer terminal 120 may search for the watchface the buyer wants to purchase through the watchface transaction web page, and may transmit the purchase request thereof to the watchface NFT market server 130.

In step 713, the watchface NFT market server 130 provides the purchased watchface to the buyer terminal 120. The watchface NFT market server 130 may transmit the purchased watchface to the buyer terminal 120 in response to the receipt of the purchase request.

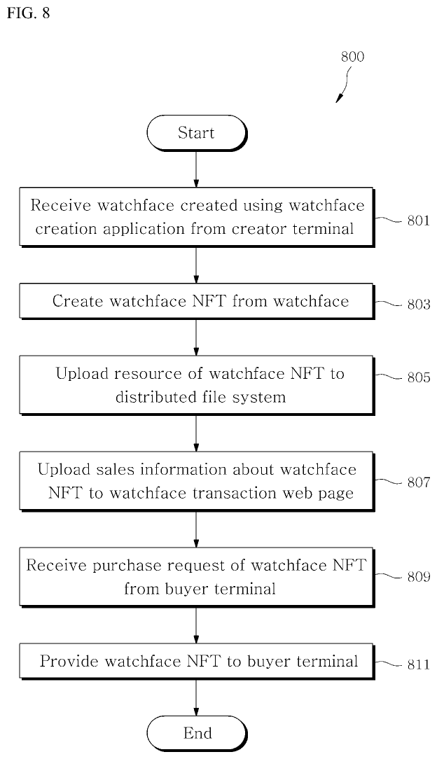

FIG. 8 shows a flowchart 800 for illustrating a method for operating the watchface NFT market server in the watchface NFT creation and transaction system 100 according to various embodiments of the present disclosure.

Referring to FIG. 8, in step 801, the watchface NFT market server 130 receives the watchface created using the watchface creation application 401 from the creator terminal 110. The watchface NFT market server 130 may receive the watchface and the sales information about the sales conditions of the watchface from the creator terminal.

In step 803, the watchface NFT market server 130 creates the watchface NFT from the watchface. The watchface NFT market server 130 may add the NFT certification mark to the watchface received from the creator terminal 110, and may mint the watchface having the NFT certification mark added thereto to create the watchface NFT.

According to one embodiment of the present disclosure, after receiving the watchface, the watchface NFT market server 130 may query at least one of the creator or the buyer whether the at least one of the creator or the buyer wants to add the NFT certification mark to the watchface. The watchface NFT market server 130 may determine whether the NFT certification mark is to be added thereto, based on the response to the query. The watchface NFT market server 130 may transmit the decision request to decide whether to add an NFT certification mark to the watchface to the creator terminal 110, and may receive, from the creator terminal 110, a response indicating deciding to adding the NFT certification mark to the watchface, and may add the NFT certification mark to the watchface based on the reception of the response, and may mint the watchface having the NFT certification mark added thereto to create the watchface NFT.

In step 805, the watchface NFT market server 130 uploads the resource of the watchface NFT to the distributed file system. The watchface NFT market server 130 may store the watchface NFT in the blockchain network. Specifically, the watchface NFT market server 130 may store the watchface NFT in the blockchain network through IPFS.

In step 807, the watchface NFT market server 130 uploads the watchface sales information to the watchface transaction web page. The watchface NFT market server 130 may induce sales of the watchface on the watchface transaction web page using the NFT market service application 411.

In step 809, the watchface NFT market server 130 receives the purchase request of the watchface NFT from the buyer terminal 120. The watchface NFT market server 130 may receive the purchase request requesting the purchase of the watchface from the buyer terminal 120.

In step 811, the watchface NFT market server 130 provides the purchased watchface NFT to the buyer terminal 120. The watchface NFT market server 130 may provide the purchased watchface NFT to the buyer terminal 120 in response to the reception of the buyer's purchase request.

When the watchface NFT market server 130 has received the purchase request of the watchface NFT from the buyer terminal 120, the watchface NFT market server 130 may provide the resources of the watchface NFT to the buyer terminal 120 through IPFS.

The watchface NFT market server 130 may add the security mark to the watchface. According to one embodiment of the present disclosure, the watchface NFT market server 130 may extract the plurality of mark units from the creator's identifier, and may generate the adding-related information about the locations in the watchface at which the plurality of mark units are respectively added to the watchface, and may create the security mark based on the adding-related information, and may add the security mark to the watchface to create the modified watchface, and then may mint the modified watchface to create the watchface NFT.

The methods according to the embodiments as described in the claims or specifications of the present disclosure may be implemented in the form of hardware, software, or a combination of hardware and software. The method according to the embodiment may be implemented in the form of program instructions that may be executed through various computer means and may be recorded on a computer-readable medium, or may be implemented based on a computer program combined with hardware and stored in a computer-readable recording medium.

When the method is implemented based on the software, the computer-readable storage medium that stores therein one or more programs (software modules) may be provided. The one or more programs stored in the computer-readable storage medium are configured to be executed by one or more processors in an electronic device. The one or more programs may include instructions that cause the electronic device to execute the methods according to the embodiments as described in the claims or specifications of the present disclosure.

This program (software module, software) may be stored in random access memory, non-volatile memory including flash memory, read only memory (ROM), and electrically erasable programmable ROM (EEPROM), a magnetic disc storage device, compact disc-ROM (CD-ROM), digital versatile disc (DVD), or optical storage devices in other forms, or magnetic cassette. Alternatively, the program may be stored in a memory composed of a combination of some or all thereof. Furthermore, each constituent memory may include multiple memories.

Furthermore, the program may be stored in an attachable storage device that may be accessed through a communication network such as the Internet, an intranet, a local area network (LAN), a wide area network (WAN), or a storage area network (SAN), or a combination thereof. This storage device may be connected to a device for performing the embodiment of the present disclosure through an external port. Furthermore, a separate storage device on the communications network may be able to access the device for performing the embodiments of the present disclosure.

In the specific embodiments of the present disclosure as described above, the component has been expressed in a singular or plural form depending on the specific embodiment as presented. However, the singular or plural expression has been selected to suit the situation presented for the convenience of description. The present disclosure is not limited to the singular or plural form of the component. The component expressed in the plural form may be the singular component, or vice versa.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A watchface non-fungible token (NFT) creation and transaction system for brokering watchface transaction based on a blockchain network, the watchface NFT creation and transaction system comprising:
a creator terminal configured to create a watchface using a watchface creation application;
a watchface NFT market server configured to:
create a watchface NFT from the watchface;
upload a resource of the watchface NFT to a distributed file system; and
broker transaction of the watchface NFT via a watchface transaction web page; and
a buyer terminal configured to purchase the watchface NFT via a watchface transaction web page.

2. The watchface NFT creation and transaction system of claim 1, wherein the watchface NFT market server is configured to:
transmit a decision request to decide whether to add an NFT certification mark to the watchface to the creator terminal;
receive, from the creator terminal, a response indicating deciding to adding the NFT certification mark to the watchface;
add the NFT certification mark to the watchface based on the reception of the response; and
mint the watchface having the NFT certification mark added thereto to create the watchface NFT.

3. The watchface NFT creation and transaction system of claim 1, wherein the watchface NFT market server is configured to:
receive a purchase request of the watchface NFT from the buyer terminal; and
provide the resource of the watchface NFT to the buyer terminal via the distributed file system.

4. The watchface NFT creation and transaction system of claim 3, wherein the watchface NFT market server is configured to:
extract a plurality of mark units from an identifier of the creator who has created the watchface;
generate adding-related information about positions in the watchface at which the plurality of mark units are respectively added to the watchface;
create a security mark based on the adding-related information;
add the created security mark to the watchface to create a modified watchface; and
mint the modified watchface to create the watchface NFT.

5. A watchface non-fungible token (NFT) creation and transaction system for brokering watchface transaction based on a blockchain network, the watchface NFT creation and transaction system comprising:
a creator terminal configured to obtain an NFT image from a digital wallet of a creator and to create a basic watchface displaying the NFT image using a watchface creation application;
a watchface NFT market server configured to add an NFT certification mark to the basic watchface to create a combination watchface, and to broker transaction of the combination watchface via a watchface transaction web page; and
a buyer terminal configured to purchase the combination watchface via the watchface transaction web page.
